(19) United States
(12) Patent Application Publication
(10) Pub. No.: US 2013/0128094 A1
(43) Pub. Date: May 23, 2013

(54) IMAGING APPARATUS, IMAGING CONTROL METHOD, AND PROGRAM

(71) Applicant: Sony Corporation, Tokyo (JP)

(72) Inventors: Tetsuo Mise, Tokyo (JP); Kazuhito Taneoka, Saitama (JP); Naoki Midorikawa, Tokyo (JP)

(73) Assignee: SONY CORPORATION, Tokyo (JP)

(21) Appl. No.: 13/670,624

(22) Filed: Nov. 7, 2012

(30) Foreign Application Priority Data
Nov. 17, 2011 (JP) 2011-251816

(51) Int. Cl. H04N 5/232

(52) U.S. Cl. CPC H04N 5/23296
USPC 348/335

(57) ABSTRACT

An imaging apparatus includes: an imaging optical system using a zoom lens and a focus lens; an optical system driving unit configured to drive the imaging optical system; and a controller configured to prevent an avoidance operation of avoiding an influence of hysteresis of a position of the zoom lens having the hysteresis with respect to a driving direction of the zoom lens in a first operation mode of recording an moving image and to control the optical system driving unit to perform the avoidance operation at a predetermined timing in a second operation mode different from the first operation mode.

### CROSS-REFERENCE TO RELATED APPLICATION

The present application claims priority from Japanese Patent Application No. JP 2011-251816 filed in the Japanese Patent Office on Nov. 17, 2011, the entire content of which is incorporated herein by reference.

### BACKGROUND

The present technology relates to an imaging apparatus, an imaging control method, and a program. More particularly, the present technology performs a zoom operation with excellent quality.

When a position of a zoom lens is moved to change an imaging magnification, the imaging apparatus keeps a subject image focused on a light receiving surface of an imaging element, so that a focus lens is driven at a predetermined position with respect to the position of the zoom lens.

Moreover, in the imaging apparatus which employs, for example, a DC motor for driving the zoom lens, the zoom lens may be displaced by gear backlash used in a drive unit of the zoom lens and mechanical wobble of the drive unit and the like. Therefore, in a case where the zoom lens is displaced at the time of moving the zoom lens to a desired position, when the focus lens is driven based on a cam curve representing a correspondence relation between the position of the focus lens which comes into focus and the position of the zoom lens, it may be difficult to focus on the subject image. As a result, in Japanese Patent Application Laid-Open No. 2001-208948, a zoom lens is moved in a predetermined direction and then is moved to a desired position in an opposite direction, thereby preventing the displacement of the zoom lens. Meanwhile, Japanese Patent Application Laid-Open Nos. 2002-267917 and 2011-158919 describe examples of a cam mechanism of a lens barrel, for example.

However, a recent imaging apparatus is provided with a still image mode of recording a still image on a recording medium and an operation mode of recording a moving image on the recording medium. In the imaging apparatus, for example, when an avoidance operation of avoiding an influence of hysteresis of a position of a zoom lens having the hysteresis with respect to a driving direction of the zoom lens is performed in a moving image recording mode, variation in an angle of view and operation sound due to the avoidance operation are recorded. Further, along with achievement of higher definition of the moving image, the variation in the angle of view is prominent and it is difficult to perform a zoom operation with excellent quality.

Therefore, in the present technology, it is desirable to provide an imaging apparatus, an imaging control method, and a program that are capable of performing a zoom operation with excellent quality.

### SUMMARY

According to an embodiment of the present technology, there is provided an imaging apparatus including: An imaging apparatus, including: an imaging optical system using a zoom lens and a focus lens; an optical system driving unit configured to drive the imaging optical system; and a controller configured to prevent an avoidance operation of avoiding an influence of hysteresis of a position of the zoom lens having the hysteresis with respect to a driving direction of the zoom lens in a first operation mode of recording an moving image and to control the optical system driving unit to perform the avoidance operation at a predetermined timing in a second operation mode different from the first operation mode.

In the embodiment of the present technology, when the position of the zoom lens of the imaging optical system driven by the optical system driving unit has the hysteresis with respect to the driving direction of the zoom lens, in the first operation mode of recording the moving image, the avoidance operation of avoiding a difference in the position of the zoom lens caused by the hysteresis is prevented. Moreover, in the second operation mode different from the first operation mode, for example, in a still image mode of recording a still image or an operation mode of capturing the still image during the capture of the moving image, the avoidance operation is performed at the desired timing, for example, at a time of shifting the first operation mode to the second operation mode. Moreover, when a zoom operation of moving the zoom lens to the direction opposite to such a first direction that the zoom lens is positioned at a desired position is completed and a completion of a panning operation or a tilting operation is detected, it is determined that a scene change is detected and the avoidance operation is performed. Moreover, in the still image recording, the avoidance operation is performed and then a focus adjustment operation is performed. Further, during the avoidance operation, a predetermined image output or freeze of a captured image is performed. It should be noted that the operation mode may include an operation mode in which recording of the moving image is in a stand-by state.

According to another embodiment of the present technology, there is provided an imaging control method including: preventing an avoidance operation of avoiding, in an imaging optical system using a zoom lens and a focus lens, an influence of hysteresis of a position of the zoom lens having the hysteresis with respect to a driving direction of the zoom lens in a first operation mode of recording an moving image; and controlling an optical system driving unit configured to drive the imaging optical system to perform the avoidance operation at a predetermined timing in a second operation mode different from the first operation mode.

According to still another embodiment of the present technology, there is provided a program that causes a computer to control an optical system driving unit configured to drive an imaging optical system using a zoom lens and a focus lens, the program causing the computer to execute: preventing an avoidance operation of avoiding an influence of hysteresis of a position of the zoom lens having the hysteresis with respect to a driving direction of the zoom lens in a first operation mode of recording an moving image; and controlling the optical system driving unit to perform the avoidance operation at a predetermined timing in a second operation mode different from the first operation mode.

It should be noted that the program according to the embodiment of the present technology is a program that can be provided to any general-purpose computers that can execute various program codes, in computer-readable forms of recording media such as an optical disk, a magnetic disk, and a semiconductor memory and communication media such as networks. By providing such a program in the computer-readable forms, the processing corresponding to the program can be realized on the computer.

According to the embodiments of the present technology, in the first operation mode of recording the moving image, the avoidance operation of avoiding the influence of hysteresis of the position of the zoom lens having the hysteresis with respect to the driving direction of the zoom lens is prevented. Moreover, in the second operation mode different from the first operation mode, the optical system driving unit configured to drive the imaging optical system using the zoom lens and the focus lens is controlled to perform the avoidance operation at a predetermined timing. Therefore, even when the zoom operation is performed during recording of the moving image, it is possible to prevent the variation in the angle of view due to the avoidance operation of avoiding the influence of the hysteresis. Moreover, since the avoidance operation is performed in the second operation mode different from the first operation mode, the influence of the hysteresis is avoided, so that the zoom lens can be positioned at the desired position. Therefore, the zoom operation with excellent quality can be performed.

These and other objects, features and advantages of the present disclosure will become more apparent in light of the following detailed description of best mode embodiments thereof, as illustrated in the accompanying drawings.

### BRIEF DESCRIPTION OF DRAWINGS

FIG. 1 is a diagram showing a schematic configuration of an imaging apparatus;

FIG. 2 is a diagram showing transition of an operation mode;

FIG. 3 is a diagram for explaining a scan AF operation;

FIG. 4 is a diagram showing an example of a cam curve;

FIG. 5 is a diagram showing an example of a schematic configuration of a zoom lens driving unit;

FIGS. 6A to 6D are diagrams showing examples of a cam mechanism;

FIGS. 7A and 7B are diagrams showing a hysteresis error of a position of a zoom lens in a modeled form;

FIGS. 8A to 8D are diagrams showing avoidance operations of the hysteresis error;

FIG. 9 is a flowchart showing the avoidance operation of the hysteresis error;

FIGS. 10A and 10B are diagrams showing the operation mode and the avoidance operation of the hysteresis error;

FIG. 11 is a diagram showing an example of a case where a moving image recording mode is transitioned to a still image mode while the avoidance operation of the hysteresis error is not performed;

FIGS. 12A to 12C are diagrams showing examples of cases where the avoidance operation of the hysteresis error is performed when the moving image recording mode is transitioned to the still image mode;

FIG. 13 is a flowchart showing a case where the avoidance operation of the hysteresis error is performed when the moving image recording mode is transitioned to the still image mode; and

FIG. 14 is a flowchart showing a case where an image output is controlled so that a variation in an angle of view is not prominent during the avoidance operation of the hysteresis error.

### DETAILED DESCRIPTION OF EMBODIMENTS

In the following, embodiments for carrying out the present technology will be described. The description will be given below in accordance with the following order.

1. Configuration of imaging apparatus

2. Operation of imaging apparatus

3. Focus adjustment operation and zoom operation of imaging apparatus

4. Avoidance operation of hysteresis error in zoom lens

5. Operation mode and avoidance operation of hysteresis error

6. Other examples of avoidance operation of hysteresis error

### 1. Configuration of Imaging Apparatus

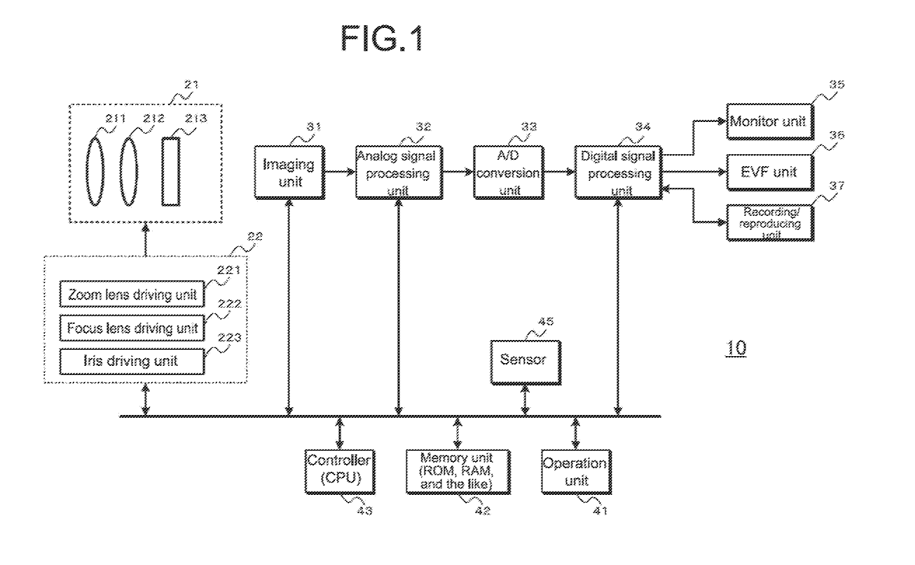

FIG. 1 shows an example of a schematic configuration of an imaging apparatus 10. The imaging apparatus 10 includes an imaging optical system 21, an optical system driving unit 22, an imaging unit 31, an analog signal processing unit 32, an A/D conversion unit 33, a digital signal processing unit 34, a monitor unit 35, an electronic viewfinder (EVF) unit 36, and a recording/reproducing unit 37. Moreover, the imaging apparatus 10 includes an operation unit 41, a memory unit 42, and a controller 43. Further, the imaging apparatus 10 may include a sensor 45 for detecting a movement of the imaging apparatus.

The imaging optical system 21 is constituted of a zoom lens 211, a focus lens 212, an iris 213, and the like. The zoom lens 211 is a lens that is driven to enlarge or reduce a subject image formed on an imaging surface of the imaging unit 31. The focus lens 212 is a lens that is driven to focus the subject image on the imaging surface of the imaging unit 31. The iris 213 is driven to adjust an amount of light of the subject image.

The optical system driving unit 22 is constituted of a zoom lens driving unit 221, a focus lens driving unit 222, an iris driving unit 223, and the like. The zoom lens driving unit 221 drives the zoom lens 211 to enlarge or reduce the subject image formed on the imaging surface of the imaging unit 31. The focus lens driving unit 222 drives the focus lens 212 to focus the subject image on the imaging surface of the imaging unit 31. The iris driving unit 223 drives the iris 213 so that the subject image has desired brightness.

The imaging unit 31 is constituted of an imaging element such as a complementary metal oxide semiconductor (CMOS) and a charge coupled device (CCD). The imaging unit 31 performs photoelectric conversion and generates an image signal corresponding to the subject image formed on the light receiving surface of the imaging element by the imaging optical system 21. The imaging unit 31 outputs the generated image signal to the analog signal processing unit 32.

The analog signal processing unit 32 subjects the image signal supplied from the imaging unit 31 to, for example, noise removal processing or analog amplification processing such as correlated double sampling processing and outputs the resultant image signal to the A/D conversion unit 33.

The A/D conversion unit 33 converts the analog image signal supplied from the analog signal processing unit 32 into a digital image signal, and outputs the resultant digital image signal to the digital signal processing unit 34.

The digital signal processing unit 34 performs camera signal processing such as a gamma correction, a luminance adjustment, and a color correction on the image signal supplied from the A/D conversion unit 33. Moreover, the digital signal processing unit 34 performs, for example, resize processing for converting a captured image to a desired image size (the number of pixels). Further, the digital signal processing unit 34 performs compression-encoding processing and expansion-decoding processing and the like of the image signal.

The digital signal processing unit 34 outputs the image signal supplied from the A/D conversion unit 33 or the image signal subjected to the camera signal processing and the resize processing and the like to the monitor unit 35 and the EVF unit 36. Moreover, the digital signal processing unit 34 outputs, to the recording/reproducing unit 37, the image signal supplied from the A/D conversion unit 33, the image signal subjected to the camera signal processing and the resize processing and the like, or an encoded signal generated by the compression-encoding processing. Further, the digital signal processing unit 34 outputs, to the monitor unit 35 and the EVF unit 36, the image signal obtained by performing the expansion-decoding processing of the image signal supplied from the recording/reproducing unit 37 and the encoded signal supplied from the recording/reproducing unit 37.

The monitor unit 35 and the EVF unit 36 are constituted of a liquid crystal display element, an organic EL (electroluminescence) display element and the like. The monitor unit 35 and the EVF unit 36 display an image based on the image signal supplied from the digital signal processing unit 34 and therefore display a camera-through image, a recorded image, a reproduction image and the like. It should be noted that the monitor unit 35 and the EVF unit 36 also display a setting state, an operation state, an operation menu, and the like of the imaging apparatus 10.

The recording/reproducing unit 37 is constituted of a recording medium, for example, a semiconductor memory. The recording/reproducing unit 37 records the image signal or the encoded signal supplied from the digital signal processing unit 34 on the recording medium. Moreover, the recording/reproducing unit 37 reads out the image signal or the encoded signal recorded on the recording medium and outputs the signal to the digital signal processing unit 34. It should be noted that the recording medium used by the recording/reproducing unit 37 may be fixed to the recording/reproducing unit 37 or may be attachable to and detachable from the recording/reproducing unit 37.

The operation unit 41 is constituted of a release switch, a zoom switch, a recording button, an operation button for inputting various types of operation information, and the like. The operation unit 41 generates an operation signal in accordance with the switches and the buttons operated by a user and outputs the operation signal to the controller 43.

The memory unit 42 is constituted of a read only memory (ROM), a random access memory (RAM), an electrically erasable programmable read only memory (EEPROM) that is a rewritable ROM, and the like. The memory unit 42 stores a program for operating the imaging apparatus 10 and a parameter and the like used for various types of processing.

The controller 43 is constituted of a central processing unit (CPU) and the like. The controller 43 executes a program stored in the memory unit 42 and controls each unit so that the operation of the imaging apparatus 10 can be an operation according to the user operation based on the operation signal from the operation unit 41. Moreover, when the controller 43 is set in the first operation mode of recording the moving image, the controller 43 prevents the avoidance operation of avoiding the influence of hysteresis of the position of the zoom lens having the hysteresis with respect to the driving direction of the zoom lens 211. Further, when the controller 43 is set in a second operation mode different from a first operation mode, the controller 43 controls the optical system driving unit at a desired timing and performs the avoidance operation.

The sensor 45 detects the movement of imaging apparatus 10. The sensor 45 is constituted of an acceleration sensor, an angular velocity sensor and the like, and supplies a sensor signal corresponding to the movement of the imaging apparatus 10 to the controller 43. The controller 43 controls the movement of the imaging apparatus based on the sensor signal. As described later, for example, the controller 43 detects a scene change based on the sensor signal and performs the avoidance operation of avoiding the influence of the hysteresis based on the detection result.

### 2. Operation of Imaging Apparatus

The imaging apparatus 10 includes a still image mode, a moving image stand-by mode, and a moving image recording mode as the operation mode during the image capturing, for example.

When the still image mode of recording a still image is selected, the imaging apparatus 10 displays a camera-through image on the monitor unit 35 and the EVF unit 36 so that the user can determine composition of the still image. Subsequently, the imaging apparatus 10 performs a focus adjustment operation using a predetermined user operation as a trigger. For example, the imaging apparatus 10 performs a so-called scan AF operation using a half-press of the release switch as a trigger. Moreover, the imaging apparatus 10 generates the image signal of the still image at a timing when a shutter operation, for example, a full press operation of the release switch is conducted, and performs processing of recording the image signal in the recording/reproducing unit 37.

When the imaging apparatus 10 is set in the moving image stand-by mode that is a stand-by state of the moving image recording, the imaging apparatus 10 displays the camera-through image on the monitor unit 35 and the EVF unit 36 so that the user can determine composition of the moving image. Subsequently, the imaging apparatus 10 shifts the operation mode to the moving image recording mode using the predetermined user operation as a trigger. For example, when a recording start operation is carried out using the recording button, the imaging apparatus 10 shifts the operation mode from the moving image stand-by mode to the moving image recording mode. Moreover, when the imaging apparatus 10 is set in the moving image stand-by mode, the imaging apparatus performs a so-called hill-climbing AF operation as the focus adjustment operation.

When the imaging apparatus 10 is set in the moving image recording mode of recording the moving image, the imaging apparatus 10 records a captured image on the recording/reproducing unit successively. Moreover, the imaging apparatus 10 displays, on the monitor unit 35 and the EVF unit 36, the captured image to be recorded. Further, the imaging apparatus 10 shifts the operation mode from the moving image recording mode to the still image mode or the moving image recording mode according to the user operation. When the imaging apparatus 10 is set in the moving image recording mode, the imaging apparatus 10 performs the so-called hill-climbing AF operation as the focus adjustment operation.

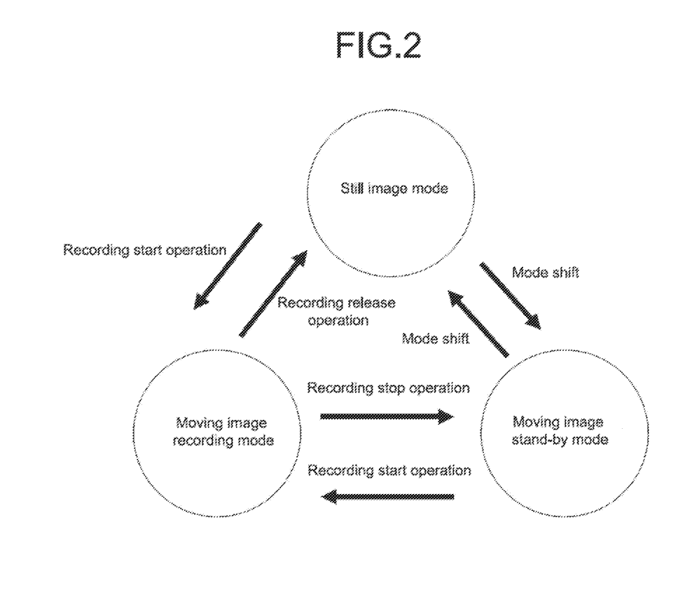

FIG. 2 shows transition of the operation mode. When the still image mode is selected, the imaging apparatus 10 shifts the operation mode from the still image mode to the moving image stand-by mode in response to a mode shift from the still image recording to the moving image recording. Moreover, when the still image mode is selected, the imaging apparatus 10 shifts the operation mode from the still image mode to the moving image recording mode in response to the recording start operation being carried out using the recording button.

When the moving image stand-by mode is selected, the imaging apparatus 10 shifts the operation mode from the moving image stand-by mode to the still image mode in response to a mode shift from the moving image recording to the still image recording. Moreover, when the moving image stand-by mode is selected, the imaging apparatus 10 shifts the operation mode from the moving image stand-by mode to the moving image recording mode in response to the recording start operation being carried out using the recording button.

When the moving image recording mode is selected, the imaging apparatus 10 shifts the operation mode from the moving image recording mode to the moving image stand-by mode in response to a recording stop operation being carried out using the recording button. Moreover, when the moving image recording mode is selected, the imaging apparatus 10 shifts the operation mode from the moving image recording mode to the still image mode in response to a recording release operation, for example, an operation of recording the still image during recording of the moving image or an operation of suspending the recording of the moving image and recording the still image.

### 3. Focus Adjustment Operation and Zoom Operation of Imaging Apparatus

Next, a focus adjustment operation and a zoom operation of the imaging apparatus will be described. In the focus adjustment operation using an image signal, the focus lens 212 is driven so that a contrast of a captured image is used to focus on a desired subject. That is, when the desired subject is focused, the captured image of the desired subject has a high contrast. Therefore, the imaging apparatus 10 extracts and integrates a high frequency component of an image in a predetermined area in the captured image, calculates an evaluation value and drives the focus lens 212 so that the evaluation value becomes a maximum value.

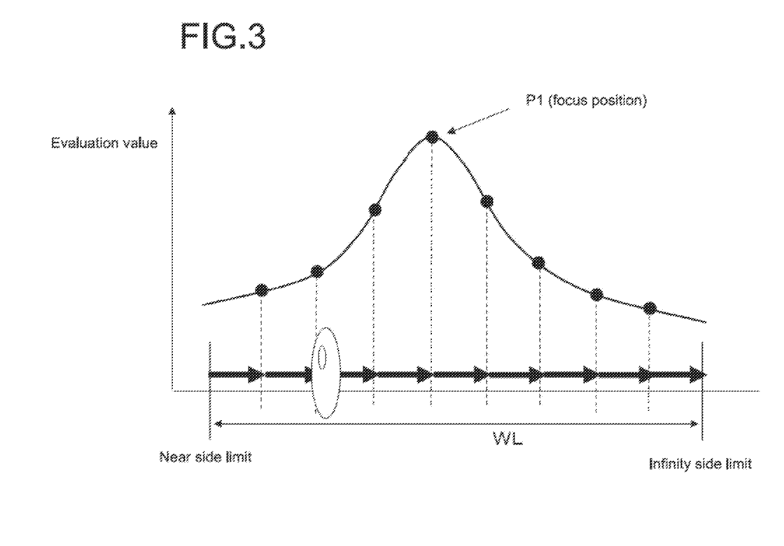

In the focus adjustment operation, the above-described scan AF operation and the hill-climbing AF operation are widely known. As shown in FIG. 3, the scan AF operation is a method of calculating the evaluation value of a specific focus lens position range WL at a specific interval and moving the focus lens 212 to a position P1 at which the evaluation value is maximum. Moreover, the hill-climbing AF operation is a method of performing a servo operation so that the position of the focus lens 212 is maintained at a position where the evaluation value is maximum.

Although the scan AF operation comes into focus for a short time almost all the scenes, when a distance to the subject is changed, the subject image formed on the imaging surface is blurred, so that the scan AF operation applies to the still image mode. Moreover, although the hill-climbing AF operation takes time to come into focus, even when the distance to the subject is changed, it is possible to keep coming into focus, so that the hill-climbing AF operation applies to the moving image stand-by mode and the moving image recording mode.

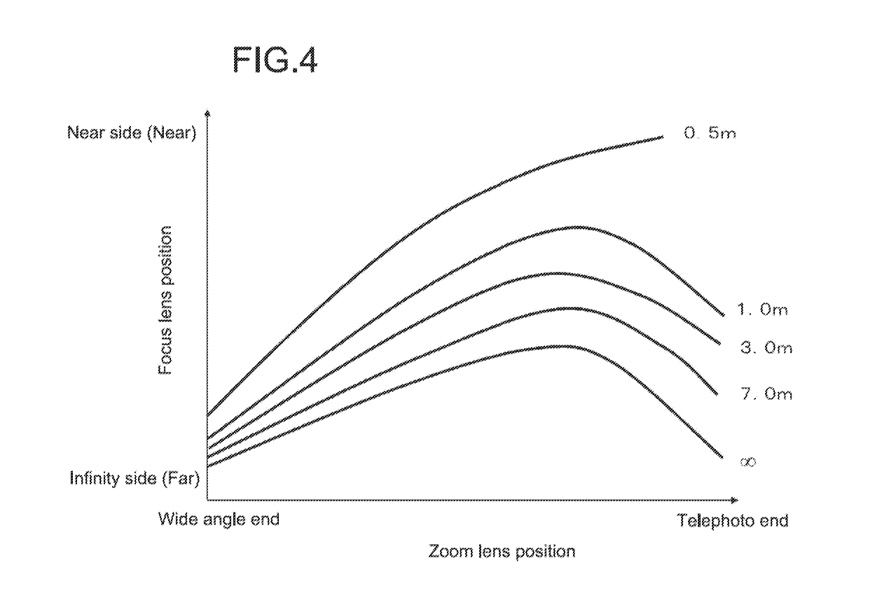

In the focus adjustment operation, the position of the focus lens 212 that comes into focus has a correspondence relation with the position of the zoom lens 211, and a curve representing this correspondence relation is referred to as a cam curve. FIG. 4 shows an example of the cam curve. A horizontal axis represents the position of the zoom lens (wide angle end through telephoto end) and a vertical axis represents the position of the focus lens 212 (infinity side through near side). FIG. 4 shows a track of positions of the focus lens that comes into focus for each of a plurality of different subject distances (0.5 m, 1.0 m, 3.0 m, 7.0 m, and ∞). The curves shown in FIG. 4 are referred to as the cam curve. Therefore, when the zoom lens 211 is moved, the focus lens 212 is moved along the curve (cam curve) corresponding to the subject distance, so that the focusing can be maintained. For example, when the zoom lens 211 is moved from the wide angle end to the telephoto end direction in a case where the subject distance is short (for example, 0.5 m), the focus lens 212 is moved from the infinity side to the near side. Moreover, when the zoom lens 211 is moved from the wide angle end to the telephoto end direction in a case where the subject distance is not short (for example, 1.0 m or more), the focus lens 212 is moved to the near side and is reversed and then is moved to the infinity side.

### 4. Avoidance Operation of Hysteresis Error in Zoom Lens

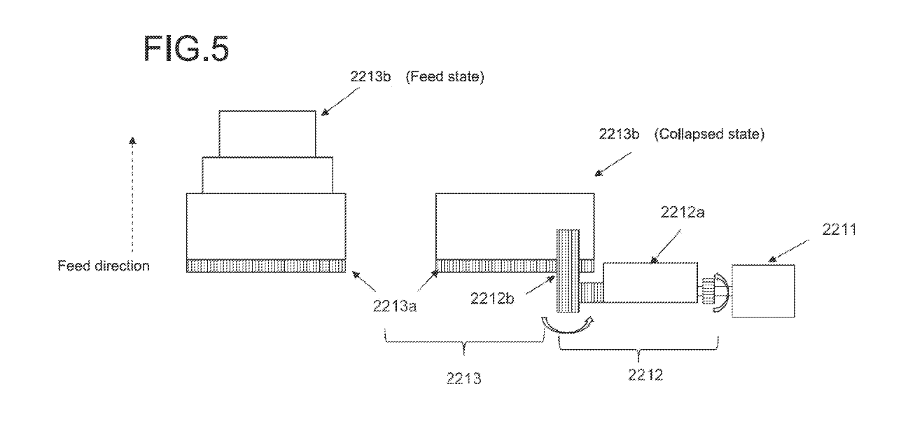

Next, the avoidance operation of a hysteresis error in the zoom lens will be described. FIG. 5 shows an example of a schematic configuration of the zoom lens driving unit 221 of the optical system driving unit 22. The zoom lens driving unit 221 includes a DC motor 2211, a drive force transmission unit 2212, and a lens feed mechanism 2213. Japanese Patent Application Laid-Open Nos. 2002-267917 and 2011-158919 describe other examples of a cam mechanism of this kind of lens barrel, for example.

The DC motor 2211 is driven based on a control signal from the controller 43. The drive force transmission unit 2212 transmits a rotation of the DC motor 2211 to the lens feed mechanism 2213. The lens feed mechanism 2213 moves the zoom lens 211 in a direction of an optical axis in response to the rotation of the DC motor 2211.

It should be noted that although various configurations are conceivable for the drive force transmission unit 2212 and the lens feed mechanism 2213, it is assumed that the drive force transmission unit 2212 is constituted of a (reduction) gear box 2212a and a drive gear 2212b in order to simplify descriptions. Moreover, it is assumed that the lens feed mechanism 2213 is constituted of a cam ring 2213a and a straight portion 2213b on which the zoom lens 211 is mounted.

The (reduction) gear box 2212a and the drive gear 2212b are driven to rotate by power from the DC motor 2211, which causes the cam ring 2213a to be rotated, thereby feeding and collapsing the straight portion 2213b.

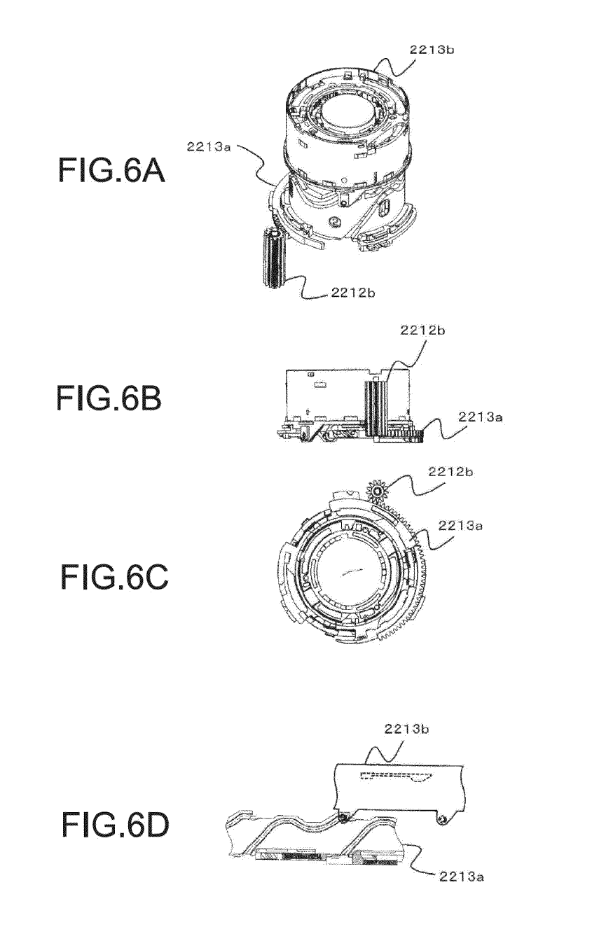

It should be noted that when the cam mechanism has, for example, a configuration shown by Japanese Patent Application Laid-Open No. 2011-158919, FIGS. 6A to 6D show components to which the drive gear 2212b and the cam ring 2213a shown in FIG. 5 correspond. FIG. 6A is a perspective view of the cam mechanism, FIG. 6B is a front view of the cam mechanism, FIG. 6C is a bottom view of the cam mechanism, and FIG. 6D is a development view of a portion of a cam groove.

By configuring the drive force transmission unit 2212 and the lens feed mechanism 2213 as shown in the figures, the zoom lens 211 can be moved in the direction of the optical axis by the rotation of the DC motor 2211.

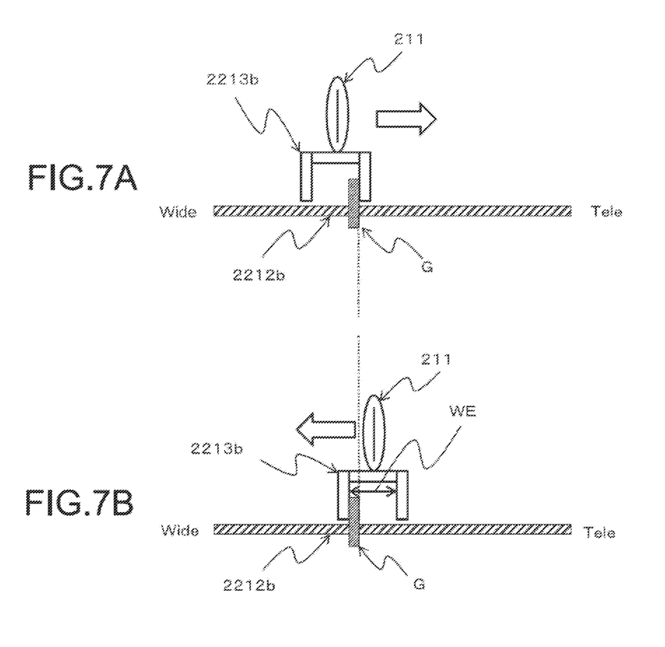

FIGS. 7A and 7B show a hysteresis error of a position of the zoom lens in a modeled form. For example, as shown in FIG. 7A, the position of the zoom lens 211 in a case of moving from a wide angle (Wide) side to a telephoto (Tele) side is set at a zoom lens position that is set based on a control signal. Herein, as shown in FIG. 7B, at the position of the zoom lens 211 in the case of moving from the telephoto side to the wide angle side, a displacement as an error WE occurs due to errors (for example, axial backlash, play, and gear backlash) caused in the drive force transmission unit 2212 and the lens feed mechanism 2213 and the like. It should be noted that a drive piece G corresponds to a gear wheel of the drive gear 2212b.

Thus, since the position of the zoom lens 211 has the hysteresis error with respect to the driving direction, the avoidance operation of avoiding the influence of the hysteresis is performed. Moreover, when the position of the zoom lens 211 in the case of moving from the wide angle side to the telephoto side is set at the zoom lens position that is set based on the control signal, moving the zoom lens 211 from the telephoto side to the wide angle side causes an error of the zoom lens position based on the error WE. The error of the zoom lens position is referred to as a hysteresis error in the following descriptions.

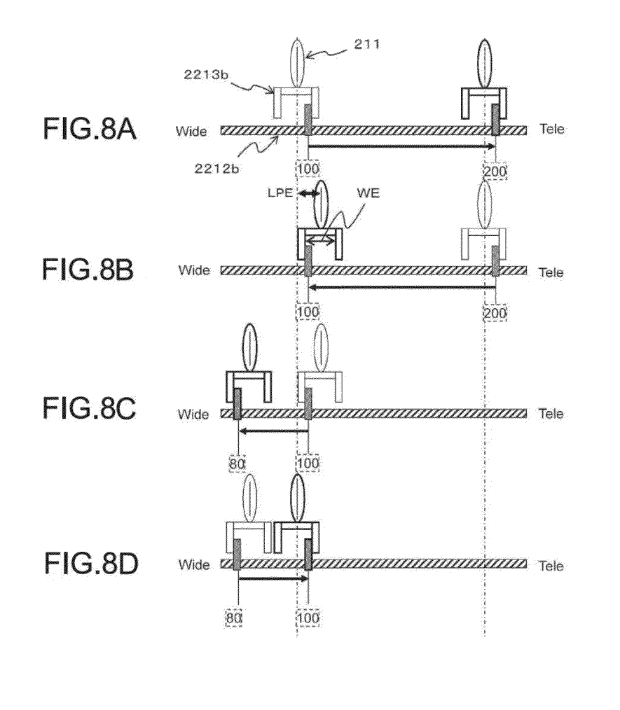

FIG. 8 shows avoidance operations of the hysteresis error. It should be noted that in the zoom lens 211, the position in the case of moving from the wide angle (Wide) side to the telephoto (Tele) side as described above is set at the zoom lens position that is set based on the control signal.

In the avoidance operation of the hysteresis error, in order to move the zoom lens 211 in a direction opposite to a moving direction for a correct zoom lens position, the zoom lens 211 is moved beyond a target position. Subsequently, the moving direction is changed to the correct zoom lens position, and processing of moving the zoom lens 211 to the target position is performed.

For example, when the zoom lens moving processing from a target position “100” to a target position “200” on the telephoto side based on the control signal is performed, the zoom lens 211 is moved from the wide angle side to the telephoto side as shown in FIG. 8A. Thus, in such a manner that the zoom lens 211 is moved to the target position “200” based on the control signal, the zoom lens 211 can be moved to the target position.

Next, when the zoom lens moving processing from the target position “200” to the target position “100” on the wide angle side based on the control signal is performed, the zoom lens 211 is moved from the telephoto side to the wide angle side as shown in FIG. 8B. Herein, when the zoom lens 211 is moved to the target position “100” based on the control signal, the error WE is caused in the drive force transmission unit 2212 and the lens feed mechanism 2213 and the like, so that the zoom lens 211 causes an error LPE of the lens position. Therefore, as shown in FIG. 8C, the zoom lens 211 is moved beyond the target position “100” by a second predetermined amount, for example, to a position “80” and is then moved to the target position “100” on the telephoto side from the wide angle side as shown in FIG. 8D. By driving the zoom lens 211 in this manner, the hysteresis error can be avoided. It should be noted that the second predetermined amount corresponds to an amount of movement from the zoom lens position (position with the hysteresis error after moving the lens shown in FIG. 8B) when the zoom lens 211 is driven to the target position on the wide angle side from the telephoto side to a position when the zoom lens 211 is moved to the wide angle side with respect to the target position (position after moving the lens shown in FIG. 8D).

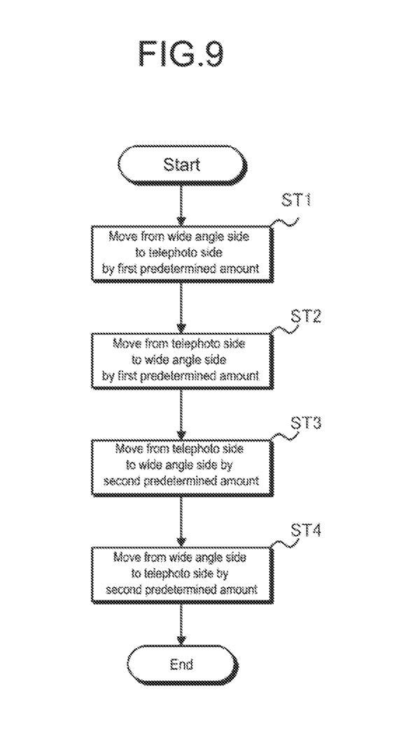

FIG. 9 shows, in a flowchart form, the avoidance operation of the hysteresis error shown in FIG. 8. In step ST1, the controller 43 moves the zoom lens 211 from the wide angle side to the telephoto side by a first predetermined amount (for example, amount corresponding to “100”) and the flow proceeds to step ST2.

In step ST2, the controller 43 moves the zoom lens 211 from telephoto side to the wide angle side by the first predetermined amount and the flow proceeds to step ST3.

In step ST3, the controller 43 further moves the zoom lens 211 from telephoto side to the wide angle side by the second predetermined amount (for example, amount corresponding to “20” in FIG. 8) and the flow proceeds to step ST4. It should be noted that the second predetermined amount corresponds to an amount of movement from the zoom lens position (position with the hysteresis error after moving the lens shown in FIG. 8B) when the zoom lens 211 is driven to the target position on the wide angle side from the telephoto side to a position when the zoom lens 211 is moved to the wide angle side with respect to the target position.

In step ST4, the controller 43 moves the zoom lens 211 from the wide angle side to the telephoto side by the second predetermined amount.

By performing such processing, even when the zoom lens 211 is moved from the telephoto side to the wide angle side, the zoom lens 211 can be accurately positioned at the zoom position as in the case of moving from the wide angle side to the telephoto side.

### 5. Operation Mode and Avoidance Operation of Hysteresis Error

Next, the operation mode and the avoidance operation of the hysteresis error will be described. In the moving image recording mode, an image is recorded from carrying out the recording start operation to carrying out the recording stop operation or the recording release operation. Moreover, when the avoidance operation of the hysteresis error is performed, the zoom lens 211 is moved beyond the target position to the wide angle side and is then moved to the target position on the telephoto side. Thus, the zoom lens 211 is moved beyond the target position to the wide angle side, and is again moved to the telephoto side to be positioned at the target position, so that the image to be recorded is an image in which the variation in the angle of view is generated.

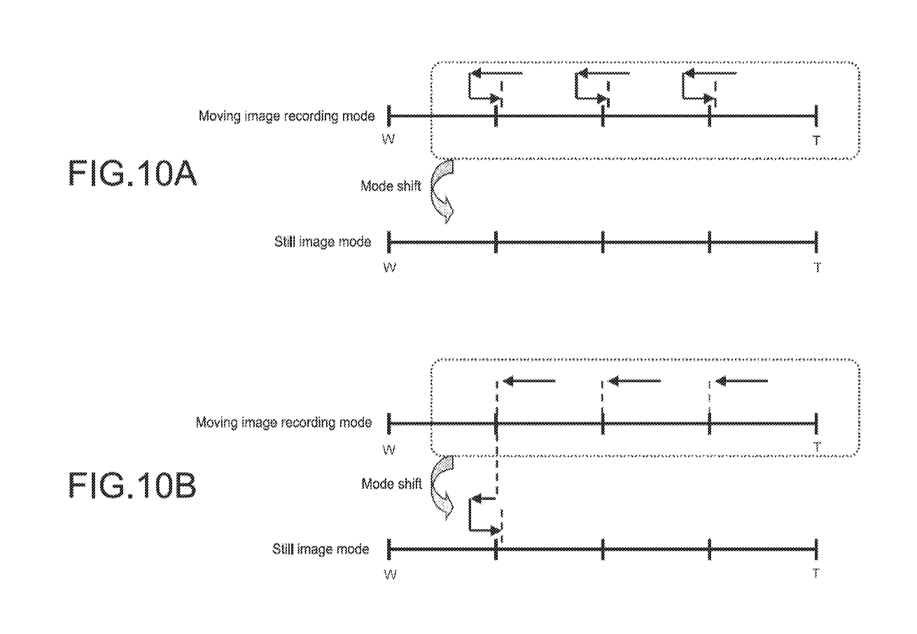

For example, when three avoidance operations of hysteresis errors are performed as shown in FIG. 10A during recording of the moving image, three variations in the angle of view are recorded. Therefore, the avoidance operation of the hysteresis error is set not to be performed as shown in FIG. 10B in the moving image recording mode. It should be noted that the hill-climbing AF operation is performed in the moving image recording mode, so that the desired subject comes into focus.

Moreover, upon transition to another mode while the avoidance operation of the hysteresis error is not performed, the position of the zoom lens 211 may cause the error LPE with respect to the zoom lens position based on the control signal. In this case, upon transition to the still image mode while the avoidance operation of the hysteresis error is not performed, the position of the zoom lens 211 causes the error LPE with respect to the position of the zoom lens based on the control signal, so that it may be difficult to come into focus. Therefore, in a mode different from the moving image recording mode, for example, the still image mode and the moving image stand-by mode, the avoidance operation of the hysteresis is set to be performed.

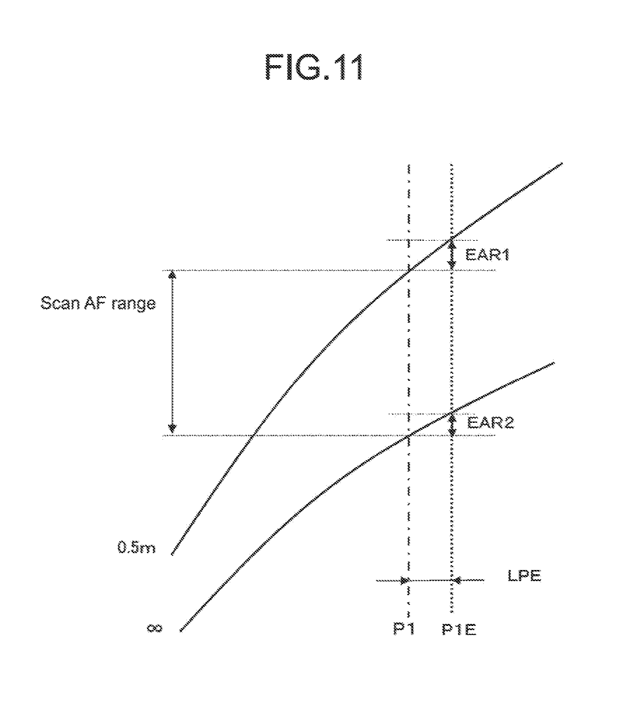

FIG. 11 shows an example of a case where the moving image recording mode is transitioned to the still image mode while the avoidance operation of the hysteresis error is not performed. For example, when the zoom lens 211 is moved from the telephoto side to the wide angle side in a case where the zoom lens 211 is driven to move to the position P1 based on the control signal, the error LPE is caused at the position of the zoom lens 211 as described above and the actual position of the zoom lens 211 is P1E.

In the still image mode, the zoom lens 211 is considered as being at the position P1 and the scan AF operation is performed. However, the actual position of the zoom lens 211 is the position P1E, so that displacements EAR1 and EAR2 are generated in a focus range and it may be difficult to perform the focus adjustment operation accurately.

Therefore, the controller 43 performs the avoidance operation of the hysteresis error in the mode different from the moving image recording mode, for example, the still image mode and the moving image stand-by mode. For example, upon transition to another mode from the moving image recording in which the avoidance operation of the hysteresis error is not performed, the avoidance operation of the hysteresis error is performed at a timing when the mode is shifted as shown in FIG. 10B.

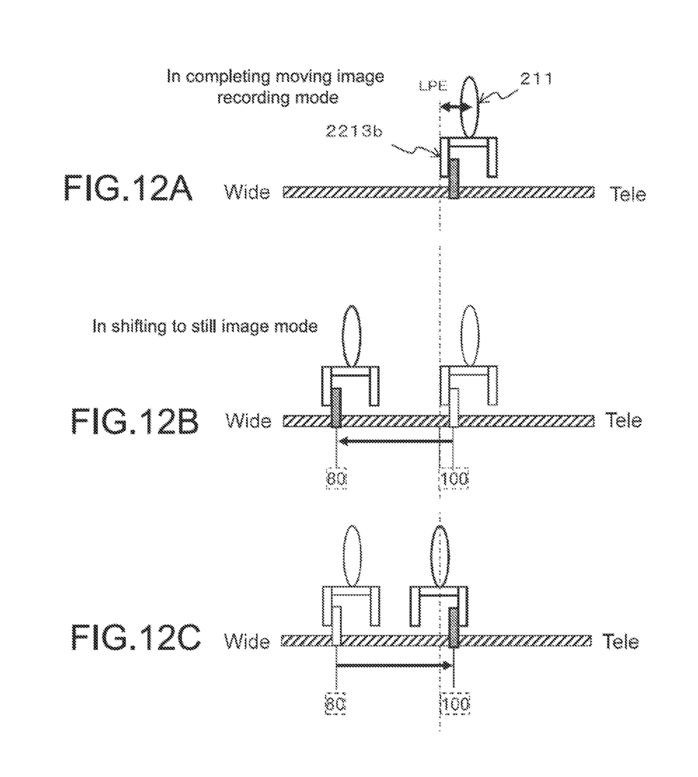

FIGS. 12A to 12C show examples of cases where the avoidance operation of the hysteresis error is performed when the moving image recording mode is transitioned to the still image mode. FIG. 12A shows an example of a zoom state when the moving image recording mode is completed. As described above, when the zoom lens 211 is moved from the telephoto side to the wide angle side, the error LPE of the position may be generated.

Therefore, when the mode is shifted from the moving image recording mode to another mode, for example, the still image mode, the controller 43 performs the avoidance operation of the hysteresis error. That is, as shown in FIG. 12B, the zoom lens 211 is moved by the second predetermined amount, for example, to the position “80” on the wide angle side from the target position “100” and is then moved to the target position “100” on the telephoto side from the wide angle side as shown in FIG. 12C. By driving the zoom lens 211 in this manner, the zoom lens 211 in the still image mode can be set at the accurate position at which the hysteresis error is avoided.

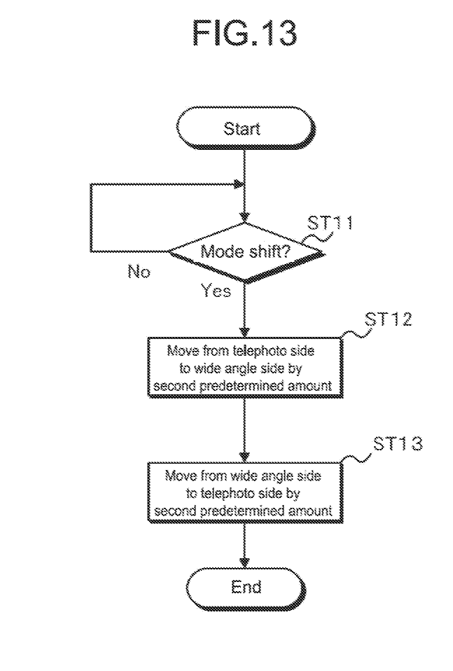

FIG. 13 shows, in a flowchart form, a case where the avoidance operation of the hysteresis error is performed when the moving image recording mode is transitioned to the still image mode. In step ST11, the controller 43 determines whether the mode is shifted from the moving image recording mode to the still image mode. In the controller 43, when the mode is not shifted, the flow returns to step ST11. When the mode is shifted, the flow proceeds to step ST12.

In step ST12, the controller 43 moves the zoom lens 211 from the telephoto side to the wide angle side by the second predetermined amount and the flow proceeds to step ST13.

In step ST13, the controller 43 moves the zoom lens 211 from the wide angle side to the telephoto side by the second predetermined amount.

By performing such processing, when the mode is shifted from the moving image recording mode to the still image mode, the position of the zoom lens 211 can be set at the accurate position at which the hysteresis error is avoided.

### 6. Other Examples of Avoidance Operation of Hysteresis Error

Incidentally, the avoidance operation of the hysteresis error is not limited to the shift from the moving image recording mode to another mode and may be performed at another timing. For example, when the scene change is determined after the transition to the still image mode, the controller 43 may perform the avoidance operation of the hysteresis error and then may perform the scan AF operation.

In the determination of the scene change, when the zoom operation is performed in the direction in which the avoidance operation of the hysteresis error is caused, for example, the direction from the telephoto side to the wide angle side, the controller 43 considers the completion of the zoom operation as the detection of the scene change. Moreover, the controller 43 determines the panning operation or the tilting operation based on the sensor signal from the sensor 45, and considers detection of the completion of the panning operation or the tilting operation as the detection of the scene change.

Further, in the controller 43, when the hysteresis error is caused in the still image, it may be difficult to perform the focus adjustment operation accurately, and therefore the avoidance operation may be performed before the focus adjustment operation. For example, the avoidance operation of the hysteresis error is performed at the timing when a release button is pressed halfway down and then the focus adjustment operation is performed.

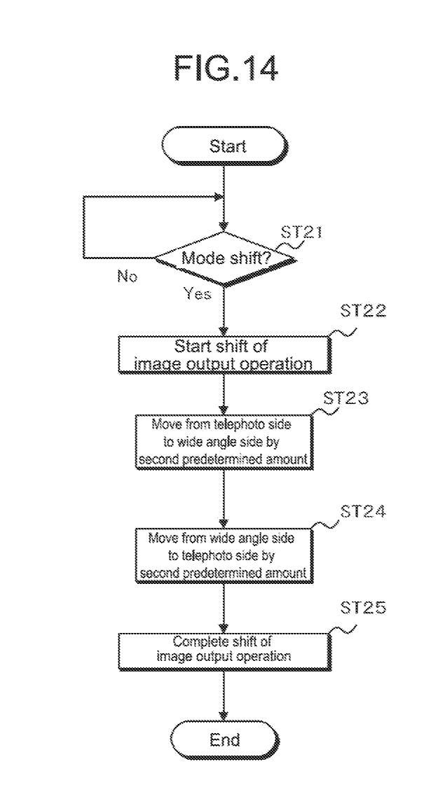

Moreover, the controller 43 may output a predetermined image, for example, a single image such as a black level and a white level or a predetermined pattern and may freeze and output the captured image so that the variation in the angle of view is not prominent during the avoidance operation of the hysteresis error. A flowchart in FIG. 14 shows a case where the image output is controlled so that the variation in the angle of view is not prominent during the avoidance operation of the hysteresis error.

In step ST21, the controller 43 determines whether the mode is shifted from the moving image recording mode to the still image mode. In the controller 43, when the mode is not shifted, the flow returns to step ST21. When the mode is shifted, the flow proceeds to step ST22.

In step ST22, the controller 43 starts shifting an image output operation. The controller 43 controls the operation of the imaging unit 31 or the digital signal processing unit 34 and outputs the single image such as a black level and a white level, the predetermine pattern, or the frozen captured image to the monitor unit 35 and the EVF unit 36 and the flows proceeds to step ST 23.

In step ST23, the controller 43 moves the zoom lens 211 from the telephoto side to the wide angle side by the second predetermined amount and the flow proceeds to step ST24.

In step ST24, the controller 43 moves the zoom lens 211 from the wide angle side to the telephoto side by the second predetermined amount and the flow proceeds to step ST25.

In step ST25, the controller 43 completes the shift of the image output operation. The controller 43 controls the operation of the imaging unit 31 or the digital signal processing unit 34, shifts the single image such as a black level and a white level, the predetermine pattern, or the frozen captured image to the camera-through image and outputs the camera-through image to the monitor unit 35 and the EVF unit 36.

By performing such processing, since the predetermined image and the frozen captured image are displayed during the avoidance operation of the hysteresis error, it is possible to control the image output so that the variation in the angle of view is not prominent.

Further, a series of processing described in the present disclosure may be executed by hardware, software, or a combined configuration of both. In the case of executing processing by software, a program in which a processing sequence is recorded may be executed by being installed in a memory within a computer incorporated in dedicated hardware, or may be executed by being installed in a general-purpose computer capable of executing various types of processing.

For example, the program may be recorded in advance in a hard disk or ROM (Read Only Memory) serving as a recording medium, or may be temporarily or eternally stored (recorded) in a removable medium such as a flexible disk, CD-ROM (Compact Disc Read Only Memory), MO (Magneto Optical) disk, DVD (Digital Versatile Disc), a magnetic disk, and a semiconductor memory card. Such a removable medium may be provided as so-called packaged software.

Moreover, the program may be transferred from a download site to a computer wirelessly, or by a cable via a network such as a LAN (Local Area Network) and the Internet in addition to being installed in a computer from a removable recording medium. The computer can receive the thus transferred program and install the program in a recording medium such as a built-in hard disk.

The present technology should not be construed to be limited to the embodiments of the aforementioned technology. The embodiments of the present technology disclose the present technology in exemplary forms, and thus, it is obvious that various modifications or alterations of the embodiments may be made by those skilled in the art without departing from the spirit of the present technology. In other words, the claims should be taken into consideration in order to determine the spirit of the present technology.

The imaging apparatus according to the embodiments of the present technology can be configured as follows.

(1) An imaging apparatus, including:

an imaging optical system using a zoom lens and a focus lens;

an optical system driving unit configured to drive the imaging optical system; and

a controller configured to prevent an avoidance operation of avoiding an influence of hysteresis of a position of the zoom lens having the hysteresis with respect to a driving direction of the zoom lens in a first operation mode of recording an moving image and to control the optical system driving unit to perform the avoidance operation at a predetermined timing in a second operation mode different from the first operation mode.

(2) The imaging apparatus according to Item (1), in which

the second operation mode is one of an operation mode of recording a still image and an operation mode of recording the still image during a capture of a moving image.

(3) The imaging apparatus according to Item (2), in which

the controller is configured to perform the avoidance operation when the first mode is shifted to the second operation mode.

(4) The imaging apparatus according to Item (2) or (3), in which

the controller is configured to perform the avoidance operation before recording of the still image and then perform a focus adjustment operation.

(5) The imaging apparatus according to any one of Items (1) to (4), in which

the second operation mode includes an operation mode in which recording of the moving image is in a stand-by state.

(6) The imaging apparatus according to any one of Items (1) to (5), in which

the controller is configured to detect a scene change and perform the avoidance operation when the scene change is detected.

(7) The imaging apparatus according to Item (6), in which

the controller is configured to determine, when a zoom operation of moving the zoom lens to a direction opposite to such a first direction that the zoom lens is positioned at a desired position is completed, that the scene change is detected.

(8) The imaging apparatus according to item (6) or (7), further including

a sensor configured to detect a movement of the image apparatus, in which

the controller is configured to determine, when the controller detects a completion of one of a panning operation and a tilting operation based on a sensor signal from the sensor, that the scene change is detected.

(9) The imaging apparatus according to any one of Items (1) to (8), in which

the controller is configured to perform one of a predetermined image output and a freeze of a captured image during the avoidance operation.

According to the imaging apparatus, the imaging control method, and the program according to the embodiments of the present technology, in the first operation mode of recording the moving image, the avoidance operation of avoiding the influence of hysteresis of the position of the zoom lens having the hysteresis with respect to the driving direction of the zoom lens is prevented. Moreover, in the second operation mode different from the first operation mode, the optical system driving unit configured to drive the imaging optical system using the zoom lens and the focus lens is controlled to perform the avoidance operation at a predetermined timing. Therefore, even when the zoom operation is performed during recording of the moving image, it is possible to prevent the variation in the angle of view due to the avoidance operation of avoiding the influence of the hysteresis. Moreover, since the avoidance operation is performed in the second operation mode different from the first operation mode, the influence of the hysteresis is avoided, so that the zoom lens can be positioned at the desired position. Therefore, the zoom operation with excellent quality can be performed and it is suited to the imaging apparatus that is capable of recording the still image and the moving image.

What is claimed is:

1. An imaging apparatus, comprising:
an imaging optical system using a zoom lens and a focus lens;
an optical system driving unit configured to drive the imaging optical system; and
a controller configured to prevent an avoidance operation of avoiding an influence of hysteresis of a position of the zoom lens having the hysteresis with respect to a driving direction of the zoom lens in a first operation mode of recording an moving image and to control the optical system driving unit to perform the avoidance operation at a predetermined timing in a second operation mode different from the first operation mode.

2. The imaging apparatus according to claim 1, wherein
the second operation mode is one of an operation mode of recording a still image and an operation mode of recording the still image during a capture of a moving image.

3. The imaging apparatus according to claim 2, wherein
the controller is configured to perform the avoidance operation when the first mode is shifted to the second operation mode.

4. The imaging apparatus according to claim 2, wherein
the controller is configured to perform the avoidance operation before recording of the still image and then perform a focus adjustment operation.

5. The imaging apparatus according to claim 1, wherein
the second operation mode includes an operation mode in which recording of the moving image is in a stand-by state.

6. The imaging apparatus according to claim 1, wherein
the controller is configured to detect a scene change and perform the avoidance operation when the scene change is detected.

7. The imaging apparatus according to claim 6, wherein
the controller is configured to determine, when a zoom operation of moving the zoom lens to a direction opposite to such a first direction that the zoom lens is positioned at a desired position is completed, that the scene change is detected.

8. The imaging apparatus according to claim 6, further comprising
a sensor configured to detect a movement of the image apparatus, wherein
the controller is configured to determine, when the controller detects a completion of one of a panning operation and a tilting operation based on a sensor signal from the sensor, that the scene change is detected.

9. The imaging apparatus according to claim 1, wherein
the controller is configured to perform one of a predetermined image output and a freeze of a captured image during the avoidance operation.

10. An imaging control method, comprising:
preventing an avoidance operation of avoiding, in an imaging optical system using a zoom lens and a focus lens, an influence of hysteresis of a position of the zoom lens having the hysteresis with respect to a driving direction of the zoom lens in a first operation mode of recording an moving image; and
controlling an optical system driving unit configured to drive the imaging optical system to perform the avoidance operation at a predetermined timing in a second operation mode different from the first operation mode.

11. A program that causes a computer to control an optical system driving unit configured to drive an imaging optical system using a zoom lens and a focus lens, the program causing the computer to execute:
preventing an avoidance operation of avoiding an influence of hysteresis of a position of the zoom lens having the hysteresis with respect to a driving direction of the zoom lens in a first operation mode of recording an moving image; and
controlling the optical system driving unit to perform the avoidance operation at a predetermined timing in a second operation mode different from the first operation mode.
